(19) United States
(12) Patent Application Publication
(10) Pub. No.: US 2011/0109088 A1
(43) Pub. Date: May 12, 2011

(54) Windsock horizontal axes turbine

(76) Inventor: Glen Edward Cook, Simpson, PA (US)

(21) Appl. No.: 12/927,161

(22) Filed: Nov. 9, 2010

Related U.S. Application Data
(60) Provisional application No. 61/281,093, filed on Nov. 12, 2009.

(51) Int. Cl. F03D 9/00; B63H 1/06; H02K 7/18; F03B 13/00

(52) U.S. Cl. 290/52; 416/132 B; 290/54; 290/55

(57) ABSTRACT

The windsock horizontal axes windmill is much like a conventional horizontal axes windmill with two unique differences. The propeller is replaced with a cone shaped turbine that runs slower with less noise very much like a squirrel cage type vertical axes windmill. The cone shaped turbine can also be seen so birds don't fly into it. The windsock turbine used underwater has the same advantages and also has the advantage of deflecting seaweed and other garbage pass the turbine because of the cone shape with the point facing the oncoming water. The windsock acts like a weedless, environmentally friendly prop in the water.

### CROSS REFERENCE TO RELATED APPLICATIONS

Windsock horizontal axes turbine

Provisional patent application No. 61/281,093 Nov. 12, 2009

### FEDERALLY SPONSORED RESEARCH

None.

### SEQUENCE LISTING

None.

### BACKGROUND OF THE INVENTION

This invention relates to a device to convert the wind or water current into electricity. With the cost of oil becoming higher every day, the problems caused by global warming and the ever growing need for power, a means of extracting energy from solar power is needed. When the sun hits the earth it warms the earth creating wind. This wind is concentrated solar power.

There have been many devices made to convert the wind into electricity; however, few can compete with the cost of coal. Conventional horizontal axes windmills use a propeller much like an airplane. These work very well but have some problems such as noise, danger to wildlife and the danger of coming apart in high winds. There is also the problem with location as many people do not want them in some areas like on top of buildings and in cities where the power is most needed. Horizontal axes windmills can convert over sixty percent of the winds power into electricity whereas a vertical axes wind turbine seldom produces over thirty five percent.

There are two kinds of vertical axes windmills used today that work; however, they produce far less power for their size than conventional horizontal windmills. They are vertical axes windmills with airfoils and a squirrel cage type windmill. These are both vertical axes windmills with the same problem, part of the air powering them is wasted bringing the sails back to the front against the wind. Most of these convert less than thirty five percent of the wind into electricity.

These vertical axes windmills have a few advantages over the propeller driven horizontal wind turbines. First, the turbines can be seen by wildlife so far less are killed. Secondly, the turbines spin slower and create less noise.

To solve these problems the windsock horizontal axes windmill is much like a conventional horizontal axes windmill with two unique differences. The propeller is replaced with a cone shaped turbine that runs slower with less noise very much like a squirrel cage type vertical axes windmill. The cone shaped turbine can also be seen so birds don't fly into it.

The windsock turbine used underwater as a current energy converter has the same advantages and also has the advantage of deflecting seaweed and other garbage pass the turbine because of the cone shape with the point facing the oncoming water. The windsock acts like a weedless prop in the water.

In view of the proceeding problems the Windsock provides a more cost efficient, quiet device that is less harmful to the environment.

### SUMMARY OF THE INVENTION

The present invention provides a device comprising of a squirrel cage type, cone shaped propeller that mounts on a horizontal shaft connected to a generator. The air enters the turbine from the open end of the cone. A tail is mounted inside the cone shaped turbine between the generator and turbine fan. A generator is mounted to the turbine shaft near the mounting pole. A mounting pole with a vertical axes mount or turret is used so the turbine can twist into the wind. The generator may be mounted on either side of the turret. This cone shaped turbine would be best mounted to a generator with the large opening towards the generator. The turbine could be mounted with the pointed or open end facing the wind. The tail that keeps the turbine facing towards the wind would be best located inside the center of the cone. The tail would be mounted to the generator or generator mounting structure.

The generator would be mounted horizontally on a turning mount much like most standard windmills. The back side of the generator would face the wind with the generator shaft pointing in the direction of the wind. The cone shaped turbine fan would be mounted to the generator shaft with the large open end facing the generator and the wind. The tail would be mounted vertically to the generator in a way that it would move with the generator into the wind.

The windmill could have the pointed end of the cone shaped turbine mounted to face the wind. This would be helpful with very large turbines.

This device could also be used in water when mounted below a floating base and anchored to extract power from the water current. In this application the tail and turning mount would not be used. The floating mount would best be elongated or boat shaped. The float would be anchored to the front end of the float where the point of the windsock is facing. There would be a rudder at the rear of the float to take the place of the tail used on the windmill version. The water current would then keep the pointed end of the turbine facing into the current.

### BRIEF DESCRIPTION OF SEVERAL VIEWS OF THE DRAWINGS

FIG. 1 is a top 3D view of a windsock used as a windmill looking at the side and into the cone shaped turbine with the generator on the opposite side of the turret from the turbine.

FIG. 2 is a 3D view of the windsock used as a windmill looking at the side and at the inside of the turbine with the generator on the same side of the turret as the turbine.

FIG. 3 is a view of a windsock used as a water current device with the point of the cone shaped turbine facing into the water current.

FIG. 4 is a side view of the windsock with the pointed end of the turbine facing into the wind.

### DRAWING REFERENCE NUMBERS

The windsock comprises the following parts:
1 Blade
2 Tail
3 Hub
4 Mounting Pole
5 Turret
6 Drive Shaft
7 Generator
8 Generator Mount
9 Rudder
10 Float

### DETAIL DESCRIPTION OF THIS INVENTION

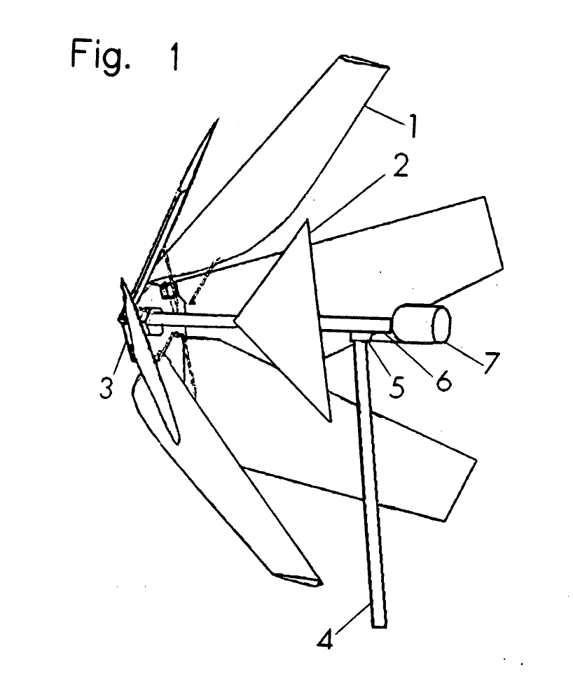

The present invention comprises a cone shaped turbine fan mounted horizontally as seen in FIG. 1

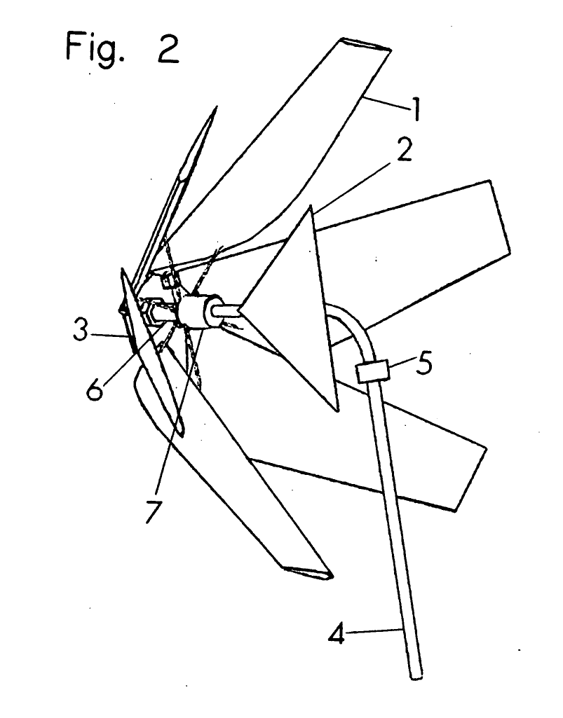

Looking at FIG. 2 we see a cone shaped turbine fan that is mounted horizontal on the generator shaft 6. The generator 7 is mounted on a turret 5 that will spin 360 degrees so it will always face the open side of the turbine into the wind. A mounting pole 4 extends vertically down to a stationary point. A tail 2 in mounted to the generator 7.

The turbine is constructed from a hub 3 that connects the blades 1 and the drive shaft 6. The hub 3 could be a flat disk, cone shaped or any shape able to connect one end of each blade 1 and one end of the drive shaft 6. When the unit is used in water a cone shaped hub 3 would be best.

Unlike most horizontal windmills with the propeller facing the wind, the back of the windsock generator 7 faces the wind and the generator shaft 6 points towards the inside of the cone shaped turbine. The generator shaft 6 extends into the cone shaped windsock turbine from the large opening and is connected to the inside of the pointed end of the turbine hub 3. The blades 1 of the turbine are connected to the hub 3 at the pointed end of the turbine and extend to the large opening. The blades 1 extend from the hub 3 outward and forward towards the generator 7 from the hub 3. The turbine may have two or more blades 1. Six or eight blades 1 work the best. The blades 1 are pitched so the wind moves into the large opening of the turbine and is then forced past the pitched blades 1 to spin the turbine and generator 7. The blades 1 can be rectangular, oval or any shape able to catch the wind and spin the turbine while fitting into the cone shape. The blades 1 could have a flat surface or could be arched. The hub 3 should have as small a diameter as possible to block as little wind as possible and allow as mush surface area on the blades. 1. The back slant or angle of the blades 1 from the hub 3 could be of any angle. An angle of about forty five degrees would give a greater inside surface area that would be best for high wind areas while a smaller angle of about thirty degrees would be best for low wind areas. There must be open space between the blades 1 to allow the wind to flow through the turbine and not back up inside the cone. The space should start at the hub 3 and extent to the opposite end of the blades 1 with as little obstruction as possible. The space between the blades 1 should equal to about thirty to seventy percent of the total surface area of the inside of the cone. When the space between the blades 1 is less than about thirty percent, air is backed up by the turbine causing the oncoming wind to go around the turbine thus wasting power. The turbine is connected to the generator 7 by the drive shaft 6 which is mounted horizontally connecting the turbine to the generator 7. The generator 7 can be mounted directly above the turret 6 or on either side of the turret 6 with a mounting plate or other structure. The tail 2 is mounted to the generator 7 or a generator mounting structure so the tail 6 is and must be on the turbine side of the turret. The tail should be one or more flat plate or structures mounted horizontally as close to the turbine as possible. The tail 6 could be of any shape but would be best to be a shaped so it will extend into the inside of the cone shaped turbine. A blade 1 supporting ring or braces can be used mounted between the blades 1 at a midpoint to prevent the blades 1 from spreading. On large turbines more than one supporting ring or brace may be used between the blades 1. Any brace or supporting ring should block the wind as little as possible.

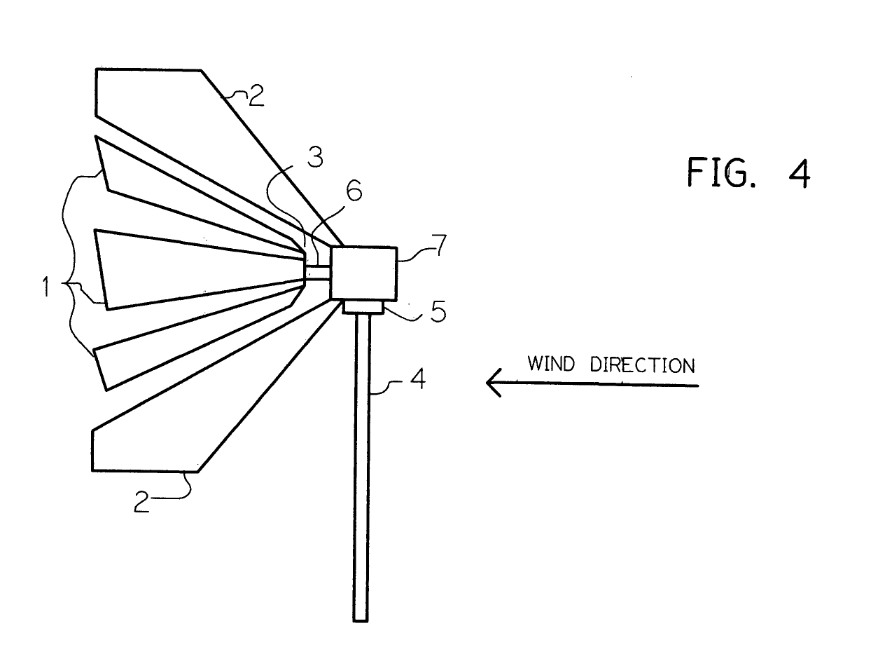

In FIG. 4 we see a view of the windsock with the pointed end of the turbine facing the wind. In this version the turbine is mounted vertically with the pointed end of the turbine facing the generator 7. The generator 7 shaft points towards the turbine and is connected to the outside of the hub 3. mounted on the opposite side of the turret from the turbine. The generator is mounted on the turret 5. The turret 5 is mounted on the top end of the mounting pole 4. This version would be best for very large turbines. On this version the air would flow from the outside of the turbine into the inside of the turbine, then out the open end of the turbine.

The advantage of this cone shaped turbine is that the area of the inside of the windsock cone is greater than the area of the diameter of the circle of the open end of the cone. This greater area spreads the air over a larger blade area than a conventional windmill without blocking the air flow through the turbine. Spreading the force of the air over a greater area causes a lower pressure per square inch on the inside of the blades 7. This also creates a low pressure on the back side of the blade 7 that is not as low as a conventional windmill. This lower difference of air pressure between the inside and outside of the blades 7 causes a lower noise or explosion sound from the air leaving the turbine. This greater blade area causes the turbine to spin slower while giving the turbine greater torque. This slower spinning turbine with greater torque can produce comparable power to a conventional windmill turbine while running much quieter and being much more friendly to birds, bats and other living things. This quieter turbine can be installed near homes and populated areas where conventional windmills are not suitable.

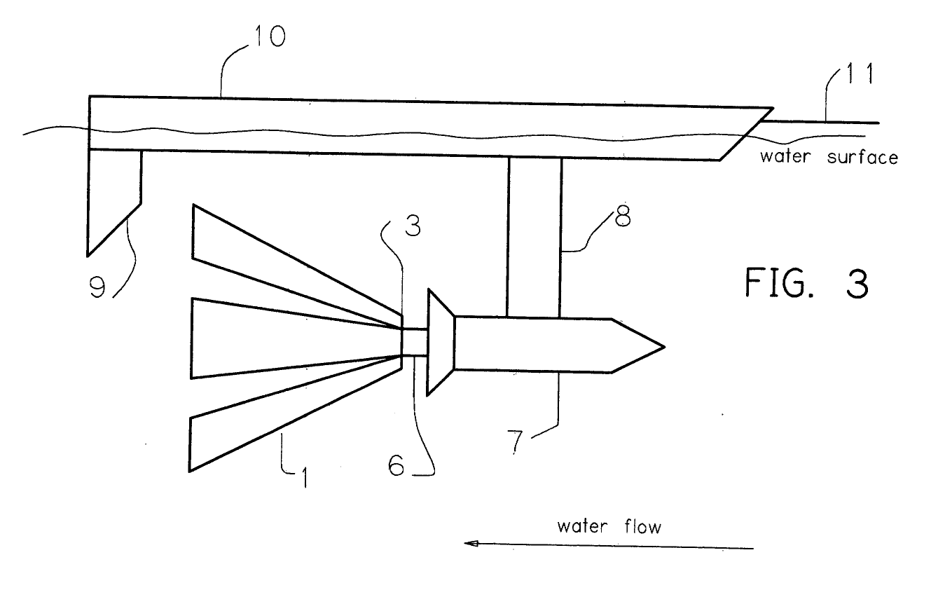

In FIG. 3 we see the windsock used in a water current device to extract electricity from the water current. A windsock turbine is mounted under a boat or a float 10 with the turbine and generator 7 underwater to extract the electricity from the flow of the water. The turbine is the same as in the windmill version except it is mounted with the point of the turbine pointing into the water flow. The hub 3 is cone shaped with the point of the cone 3 connect directly or with a drive shaft 6 to the generator 7. The water current version does not use the tail 2, the turret 5 or the mounting pole 4 as in the windmill version. As seen in FIG. 3 there is a float 10. The float 10 could be any shaped but would be best shaped like a boat or barge. The float 10 would have a connection point at the front to connect a line to a fixed point to hold the front of the float 10 to a stationary point. The rear of the float 10 would have a rudder 9 mounted to the underside to keep the float 10 aimed into the current. Generator mount 8 would be mounted to the underside of the float 10 and extent down to the generator 7. The shaft end of the generator 7 would point to the rear of the float 10. The generator 7 shaft would be connected directly or with a drive shaft 6 to the pointed end of the turbine hub 3. The water on this version would flow from the outside of the turbine to the inside.

The advantages of the windsock water current version would be the same as the windmill version with the added advantage of being able to the weed free by deflecting sea weed and other underwater garbage away from the turbine without and protecting structure. This is because the generator 7 deflects the seaweed from the generator to shaft and the sloping back of the blades 1 prevents anything from catching on them.

### Operation

On the windmill version with the open end of the turbine facing the generator, when the wind hits the windsock the wind hitting the tail 1 will spin the unit at the turret 5 and point the open end of the cone shaped turbine into the wind. The wind fills the turbine with air that flows from the inside to the outside of the cone past the blades 1. The blades 1 are pitched at an angle to cause the cone to spin thus spinning the generator 7 thus producing electricity.

On the windmill version with the pointed end of the turbine facing the generator, when the wind hits the windsock the wind hitting the tail 1 will spin the unit at the turret 5 and point the pointed end of the cone shaped turbine into the wind. The wind flows from the outside to the inside of the cone past the blades 1. The blades 1 are pitched at an angle to cause the cone to spin thus spinning the generator 7 thus producing electricity.

On the water current version the water current will hit the rudder 9 thus turning and holding the front of the float 10 into the oncoming water current. The water flowing under the float 10 will hit the turbine blades 1, flowing through the blades 1 thus spinning the turbine and generator 7 creating electricity.

What I claim as my invention is:

1. An environmentally friendly, horizontal axes windsock turbine comprising: a hub located at one end of said turbine with two or more elongated blades with one end connected to said hub and extending outward and toward the other end of said turbine with space between said blades and said blades being pitched to catch the wind to form a turbine; wherein: wind hitting the said turbine from the open end will hit the said blades spreading the force of the wind over a surface area larger than the diameter of the circle of the open end of said turbine thus causing the turbine to spin slower than a conventional windmill while increasing the torque.

2. An environmentally friendly, horizontal axes windsock turbine windmill comprising:
a. a hub located at one end of said turbine with two or more elongated blades with one end connected to the said hub and extending outward and toward the other end of said turbine with space between said blades and said blades being pitched to catch the wind to form a turbine;
b. a drive shaft connected to the center of said hub extending horizontally towards the open end of said turbine;
c. a generator mounted horizontally with the shaft connected to said drive shaft;
d. a turret mounted to said generator to allow said generator to turn in a horizontal circle, a mounting pole mounted vertically with the top of said pole connected to said turret;
e. a tail mounted to said generator extending inside the open end of said turbine;
wherein the wind hitting the said windmill will hit the said tail turning the said turbine open end into the wind thus causing the wind to enter the open end of said turbine thus hitting the pitched sides of said blades causing the said turbine to spin thus spinning the said drive shaft and said generator shaft creating electricity.

3. The environmentally friendly, horizontal axes windsock turbine windmill of claim 2 further comprising a generator mount connected to said turret extending to the opposite side of said turret from the said turbine.

4. An environmentally friendly water current device to convert the power of the moving water into electricity comprising;
a. a cone shaped hub located at one end of a turbine with two or more elongated blades with one end of said blades connected to the open end of said hub and extending outward and away from the pointed end of said hub with space between said blades and said blades being pitched to catch the water current to form a cone shaped turbine;
b. a drive shaft connected to the outside center of the pointed said hub extending horizontally away from said turbine;
c. a generator mounted horizontally with the shaft connected to said drive shaft;
d. a mount connecter from and extending upward from said generator;
e. an elongated float connected to the top of said generator mount;
f. a rudder mounted to the bottom of said float;
g. a connection device such as a ring, hook or other device in which an anchor line could be connected, mounted on the opposite end of said float from said rudder;
wherein the said float would be placed in a body of flowing water with the said connection device connected to a rope or chain to secure the said water current device and keep the oncoming water hitting the front of said device to cause the flowing water to flow around the said generator, then hitting the pointed end of said turbine thus hitting and flowing through the said pitched blades thus spinning said turbine and said generator to produce electricity.
